(19) United States
(12) Patent Application Publication
(10) Pub. No.: US 2007/0119079 A1
(43) Pub. Date: May 31, 2007

(54) Flip it

(76) Inventor: Janice Marie Dill, Valencia, CA (US)

Correspondence Address: Janice Dill-Schmidt, 27800 Mc Bean Parkway #312, Valencia, CA, 91354, US

(21) Appl. No.: 11/495,306

(22) Filed: Jul. 29, 2006

Related U.S. Application Data
(60) Provisional application No. 60/595,723, filed on Jul. 29, 2005.

(51) Int. Cl. G09F 1/00

(52) U.S. Cl. 40/124.01

(57) ABSTRACT

The Flip It is a unit that will be adhered to a computer monitor that an employee will use while at work, to inform fellow employees' of their where-abouts. The Flip It consists of a base unit with adhesive on it that will attach to the computer monitor and the base has an extended arm attached to it, which allows the cards, or tabs, which have messages, indicating the employees' where-abouts when not at their desk, to flip, or slide said cards, or tabs, over the arm, to be first and foremost, resting on the arm, just in front of the monitor's edge, so as not to obstruct the viewing of the monitor.

The present application claims the benefit of U.S. Provisional Patent Application Ser. No. 60/595,723, filed Jul. 29, 2005, which application is incorporated herein by reference in its entirety.

### FIELD OF THE INVENTION

The present invention relates to an office product used in offices where computers and monitors are used, and in particular where office workers use sticky notes to post notes on their monitors, to let fellow employees know where they are, when they are away from their desk. This product allows the employee to adhere this unit to the monitor with an adhesive backing. The backing is attached to the base. There is an extended arm which is attached to the base of the unit, and it holds cards, or tabs, that have holes, or slits in the them, that allows the cards, or tabs, to slide over the extended arm until it is resting on the front of the arm, so the message the employee wants to convey, is in front and foremost. These cards, or tabs, have messages on them such as, but not limited to, break, lunch, meeting, vacation, sick, and a custom card, or tab, that can be written on for specific locations not mentioned on said cards, or tabs. The cards, or tabs, lay on the base, message side down, when not in use. The cards, or tabs, will hang slightly over the monitor's edge, but not so as to obstruct the view of the monitor.

### BACKGROUND OF THE INVENTION

This invention will allow employees to convey their where-abouts to fellow employees when they are not at their desks in a more secure manner. The sticky note is used now for this purpose but the problem with the sticky notes is that the adhesive becomes old and does not stick any more, so they fall off. If the employee wants to keep using the same one, they use tape to adhere it to the monitor. Since the sticky note is made of paper, the ink or pencil lead smears, smudges and fades after only a few uses, and it can tear easily. An employee today, will have to re-write these sticky notes many times over and in order to re-use them, they have to be stored in a delicate safe place for future use. They easily and many times get lost, crumpled, and torn.

Therefore, a need exists for an invention that will allow employees to convey to fellow employees where they are when they are not at their desk, that will last for more than a few uses, and will not fade, smear, smudge, get torn or lost. The need for a more stationary and permanent product is needed.

### BRIEF SUMMARY OF THE INVENTION

The present invention addresses the above and other needs by providing a solid, secure unit that holds all of the same information as a sticky note, but will be stationary and will be able to be used over and over.

### BRIEF DESCRIPTION OF THE DRAWINGS

The above and other aspects of the present invention will be more apparent from the following more particular description thereof, presented in conjunction with the following drawings wherein:

FIG. 1 is a partial angle of the front view of the invention;

FIG. 2 is a partial angle of the back of the invention;

FIG. 3 is a view of the of the invention, sifting on top of a computer monitor; the broken lines are for viewing purposes of a computer monitor, only, and are in no way part of the invention.

FIG. 4 is a view of the plurality of single cards, which are part of the invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing the general principles of the invention. The scope of the invention should be determined with reference to the claims.

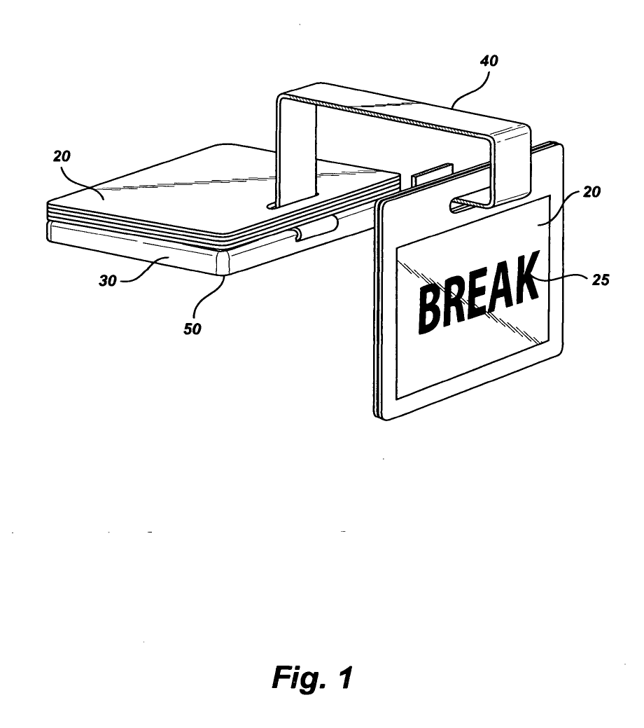

FIG. 1 is a partial angle view of the front of the invention. An adhesive pad 50, is attached to the base 30, which lays on top of a computer monitor. The cards, or tabs 20 lay flat against the top of the base 30, message side down 25. The extended arm 40 is attached to the base and extends out and over, and has several cards, or tabs 20 that slide over the arm 40, to show the desired card, or tab 20.

The structure of this invention is a free flowing avenue for the card 20 to flip over the arm 40 to display the desired message 25 in the forefront of the unit in FIG. 1. The person using this unit will be confident that this unit will not fall off of the monitor because of the adhesive pad 50 under the base 30 will secure the base 30 to the top of the monitor. The variations of this unit are unlimited as to the design of the manufacturer as to the best possible materials and design to best fit a monitor.

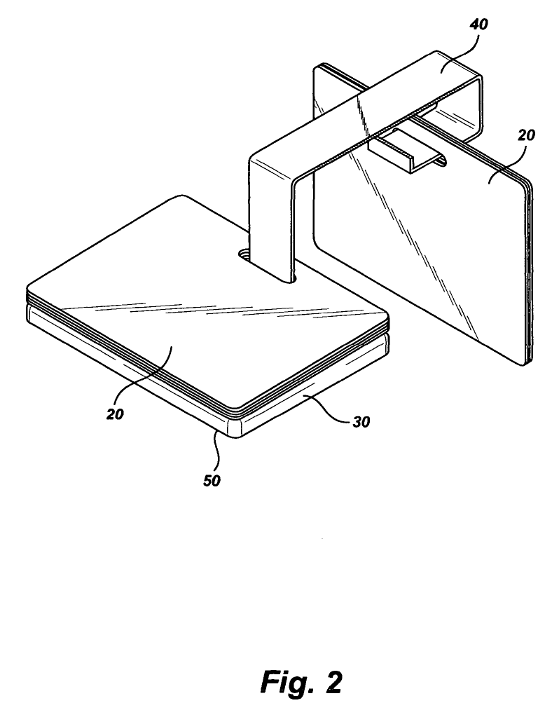

FIG. 2 is a partial angle of the back of the invention, showing the adhesive pad 50 under the base 30. The multiple of cards 20 lay flat on top of the base 30, face down when not in use. The arm 40 extends from the base 30, out and over the monitor, with the desired message card 20 showing in the forefront

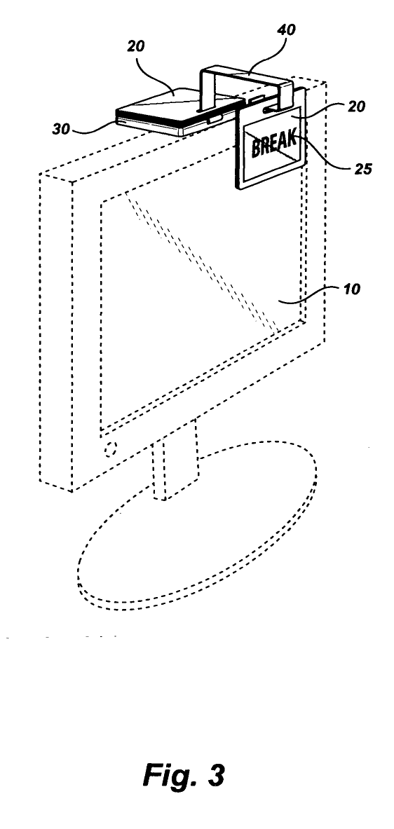

FIG. 3 is a view of the of the invention, sitting on top of a computer monitor 10; the broken lines are for viewing purposes of a computer monitor 10, only, and are in no way part of the invention. The base 30 sits on top of the monitor 10, with the cards 20 laying flat against the base 20 with the message card 25 face down. The message 25 on the card 20 slides over from the flat lying position to hang in the forefront of the monitor, but not to obstruct the viewing of the monitor 10.

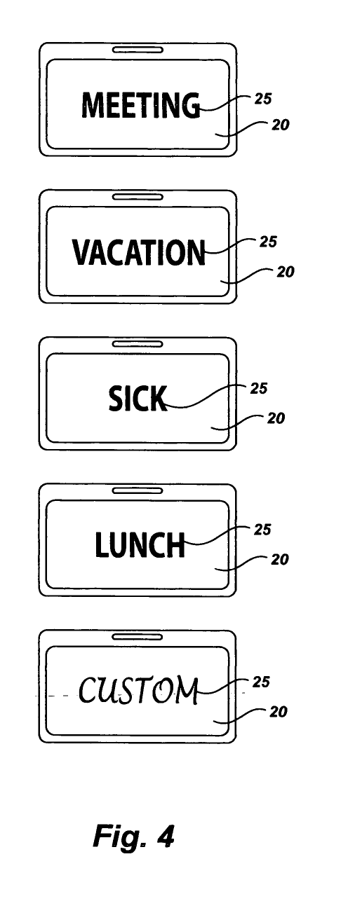

FIG. 4 is a view of the plurality of single cards, which are part of the invention. These cards 20 each will have different messages 25 on them, indicating where the employee is, when not at their desk. These messages 25 read, but are not limited to: meeting, vacation, break, lunch, sick. There is a “custom” message 25 card 20 to be written on for messages not included. The message 25 cards 20 can be partially printed and partially custom, for example, the “meeting” message 25 card 20 can say, “meeting”, but can also have a custom area, to indicate the time the employee will return from the meeting.

The adhesive pad 50 is a layer of adhesive that will attach to the computer monitor on one side and is attached to the base 30 on the other. The base 30 is connected to the arm 40. The cards 20 with messages 25 slides or flips over the arm 40 until the desired message 25 appears in the forefront of the invention.

The variations of this invention are limitless. The invention can be made of plastic, metal, aluminum, wood, or portions thereof. There can be single colors or a multitude of colors. There can be portions of white board on the message 25 cards 20 or whole white board areas. The arm 40 can be flat or round or any shape thereof. The hole in the card 20 can be any shape to fit the arm 40. The arm 40 can attach to the base 30 in any manner.

The invention operates in a simple manner. One attaches the adhesive pad 50 to the top of a computer monitor 10. When one leaves their desk, they simply flip a card 20 to the desired message 25 that best indicates where they will be while not at their desk.

<<70>>

While the invention herein disclosed has been described by means of specific embodiments and applications thereof, numerous modifications and variations could be made thereto by those skilled in the art without departing from the scope of the invention set forth in the claims.

### Number Description List

FIG. 1

20 is a card
25 is a message
30 is a base
40 is an arm
50 is an adhesive pad
   FIG. 2
20 is a card
30 is a base
40 is an arm
50 is an adhesive pad
   FIG. 3
10 is a computer monitor in broken lines and is not part of the invention
20 is a card
25 is a message
30 is a base
40 is an arm
   FIG. 4
20 is the plurality of cards with holes in them
25 is the message

What is claimed is:

1. A unit that attaches-to a computer monitor to convey employees' where-abouts when not at their desk.

2. The unit consists of several cards attached to it, that flip over the extended arm to convey the particular message that best fits where they are, when not at their desk.

3. The cards consist of such messages, but are not limited to: break, lunch, meeting, vacation, sick, and a blank card for custom writing.

4. The Flip It is a product consisting of adhesive, base, extended arm, multiple cards with messages.
1st element: adhesive
2nd element: base
3rd element: extended arm that is attached to the base and extends from the base, upward and outward to hang slightly over the computer monitor, but not as to obstruct the viewing of the monitor.
4th element: cards, or tabs with messages of where-abouts already on them, that when not in use the cards, or tabs, lay face down on the base, and when in use, flip over the extended arm to finally rest face front on the arm to show desired message.
